(19) United States
(12) Patent Application Publication
(10) Pub. No.: US 2025/0227268 A1
(43) Pub. Date: Jul. 10, 2025

(54) RELATIVE DIFFERENCE METRIC FOR FRAME CODING AND TWO-STAGE TRAINING FOR GENERATIVE FACE VIDEO COMPRESSION

(71) Applicant: Alibaba (China) Co., Ltd., Hangzhou (CN)

(72) Inventors: Renjie Zou, Beijing (CN); Bolin Chen, Beijing (CN); Ru-ling Liao, Sunnyvale, CA (US); Jie Chen, Beijing (CN); Yan Ye, San Diego, WA (US)

(21) Appl. No.: 19/008,505

(22) Filed: Jan. 2, 2025

Related U.S. Application Data
(60) Provisional application No. 63/619,305, filed on Jan. 9, 2024.

(51) Int. Cl. H04N 19/192; H04N 19/105; H04N 19/136; H04N 19/172

(52) U.S. Cl. CPC H04N 19/192; H04N 19/105; H04N 19/136; H04N 19/172

(57) ABSTRACT

Generative Face Video Compression (“GFVC”) techniques are provided to improve performance of facial video compression. A computing system is configured to compute a relative difference metric describing differences in features between frames, and determining, based on the relative difference metric, whether a current frame can be synthesized without entropy coding, or should be re-coded. A computing system is configured to perform two-stage training to stabilize Generative Adversarial Networks (“GAN”) training in GFVC.

### RELATED APPLICATIONS

The present U.S. Non-provisional Patent application claims the priority benefit of a first prior-filed U.S. Provisional Patent Application having the title “UNIFIED METRIC FOR FRAME CODING AND TWO-STAGE FOR GENERATIVE FACE VIDEO COMPRESSION,” Ser. No. 63/619,305 filed Jan. 9, 2024, The entire contents of the identified earlier-filed U.S. Provisional Patent Applications are hereby incorporated by reference into the present patent application.

### BACKGROUND

Machine learning tools are being incorporated into intra-frame coding used in video coding standards to achieve further improvements in compression efficiency over prior standards such as H.264/AVC (Advanced Video Coding) and H.265/HEVC (High Efficiency Video Coding), and, most recently, Versatile Video Coding (“VVC”). Furthermore, learning-based coding will most likely be a part of future video coding standards succeeding VVC as well.

Present image coding techniques are primarily based in lossy compression, based on a framework including transform coding, quantization, and entropy coding. For many years, lossy compression has achieved compression ratios which are suited to image capture and image storage at limited scales. However, computer systems are increasingly configured to capture and store images at much larger scales, for applications such as surveillance, streaming, data mining, and computer vision. As a result, it is desired for future image coding standards to achieve even smaller image sizes without greatly sacrificing image quality.

Machine learning has not been a part of past image coding standards, whether in the compression of still images or in intra-frame coding used in video compression. As recently as the VVC standardization process from 2018 to 2020, working groups of the ISO/IEC and ITU-T reviewed, but did not adopt, learning-based coding proposals. The 32nd meeting of the Joint Video Experts Team (“JVET”) in October 2023 convened an ad hoc group on Generative Face Video Compression (“GFVC”), including software implementation, test conditions, coordinated experimentation, and interoperability studies thereof.

There remains a need to further improve facial video compression techniques according to GFVC.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1A illustrates a block diagram of an image compression process in accordance with a variety of image coding techniques.

FIG. 1B illustrates a flowchart of a deep learning model-based video generative compression First Order Motion Model.

FIG. 1C illustrates a flowchart of a deep learning model-based video generative compression model based on compact feature representation.

FIG. 2 illustrates a flowchart of calculating a relative difference metric describing differences in features between frames, and determining, based on the relative difference metric, whether to re-code a current frame or synthesize the current frame by a generative neural network without entropy coding.

FIG. 3 illustrates a flowchart of an encoder-side sequential frame processing method according to Generative Face Video Compression (“GFVC”), and calculation of a relative difference metric based on the frame processing method according to example embodiments of the present disclosure.

FIG. 4 illustrates a flowchart of a decoder-side sequential frame processing method according to GFVC, based on a relative difference metric according to example embodiments of the present disclosure.

FIG. 5 illustrates a flowchart of two-stage training to stabilize Generative Adversarial Networks (“GAN”) training in GFVC.

FIG. 6 illustrates an example system for implementing the processes and methods described herein for computing a relative difference metric describing differences in features between frames, and determining, based on the relative difference metric, whether a current frame can be synthesized by a generative neural network without entropy coding, or should be re-coded.

### DETAILED DESCRIPTION

Example embodiments of the present disclosure provide computing a relative difference metric describing differences in features between frames, and determining, based on the relative difference metric, whether a current frame can be synthesized by a generative neural network without entropy coding, or should be re-coded; and provide two-stage training to stabilize Generative Adversarial Networks (“GAN”) training in GFVC.

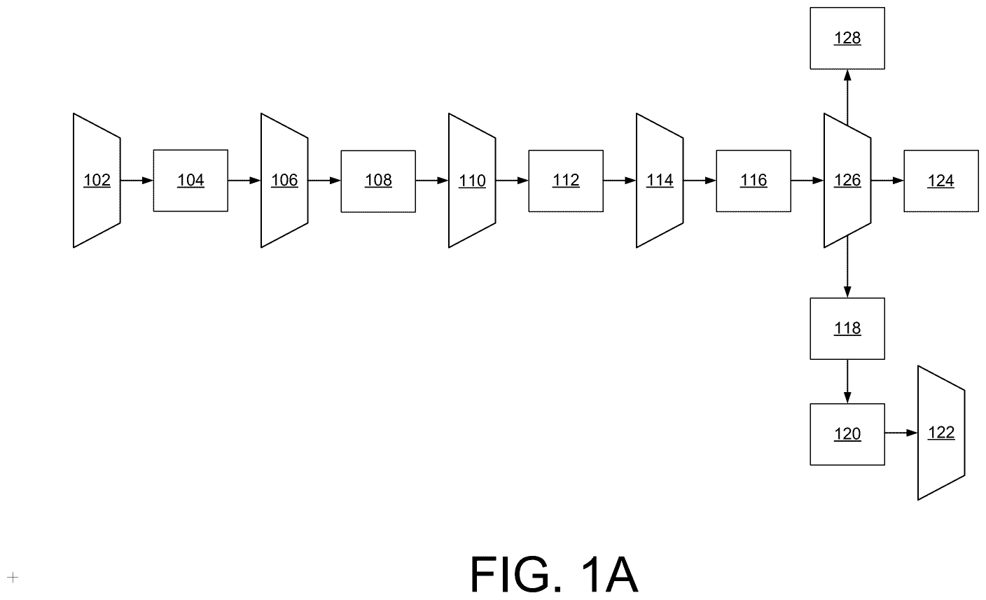

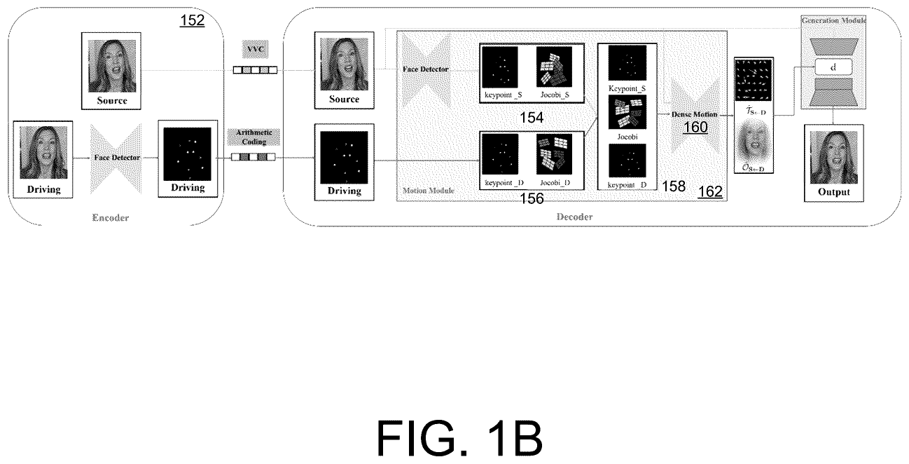

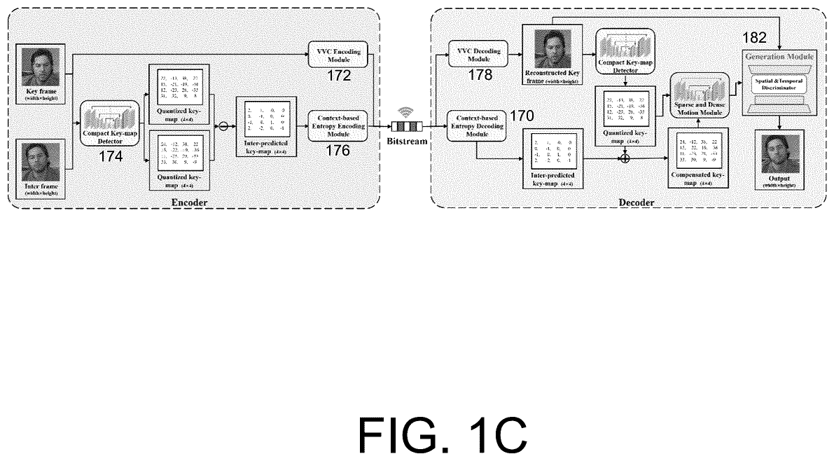

FIG. 1 illustrates a block diagram of an image compression process 100 in accordance with a variety of image coding techniques, such as those implemented by a variety of intra-frame coding techniques, such as those implemented by AVC, HEVC, and VVC. The image compression process 100 can include lossless steps and lossy steps.

It should be understood that the image compression process 100, while conforming to each of the above-mentioned standards (and to other image coding standards or techniques based on image compression, without limitation thereto), does not describe the entirety of each of the above-mentioned standards (or the entirety of other image coding standards or techniques). Furthermore, the elements of the image compression process 100 can be implemented differently according to each of the above-mentioned standards (and according to other image coding standards or techniques), without limitation.

According to an image compression process 100, a computing system is configured by one or more sets of computer-executable instructions to perform several operations upon an input picture 102. First, a computing system performs a transform operation 104 upon the input picture 102. Herein, one or more processors of the computing system transform picture data from a spatial domain representation (i.e., picture pixel data) into a frequency domain representation by a Fourier transform computation such as discrete cosine transform (“DCT”). In a frequency domain representation, the transformed picture data is represented by transform coefficients 106.

According to an image compression process 100, the computing system then performs a quantization operation 108 upon the transform coefficients 106. Herein, one or more processors of the computing system generate a quantization index 110, which stores a limited subset of the color information stored in picture data.

A computing system then performs an entropy encoding operation 112 upon the quantization index 110. Herein, one or more processors of the computing system perform a coding operation, such as arithmetic coding, wherein symbols are coded as sequences of bits depending on their probability of occurrence. The entropy encoding operation 112 yields a compressed picture 114.

One or more processors of a computing system are further configured by one or more sets of computer-executable instructions to perform several operations upon the compressed picture 114 to output the compressed picture.

For example, according to some image coding standards, a computing system performs an entropy decoding operation 116, a dequantization operation 118, and an inverse transform operation 120 upon the compressed picture 114 to output a reconstructed picture 122. By way of example, where a transform operation 104 is a DCT computation, the inverse transform operation 120 can be an inverse discrete cosine transform (“IDCT”) computation which returns a frequency domain representation of picture data to a spatial domain representation.

However, a decoded picture need not undergo an inverse transform operation 120 to be used in other computations. One or more processors of a computing system can be configured to output the compressed picture 114 in formats other than a reconstructed picture. Prior to performing an inverse transform operation 120, or instead of performing an inverse transform operation 120, one or more processors of the computing system can be configured to perform an image processing operation 124 upon a decoded picture 126 yielded by the entropy decoding operation 116.

By way of example, one or more processors of the computing system can resize a decoded picture, rotate a decoded picture, reshape a decoded picture, crop a decoded picture, rescale a decoded picture in any or all color channels thereof, shift a decoded picture by some number of pixels in any direction, alter a decoded picture in brightness or contrast, flip a decoded picture in any orientation, inject noise into a decoded picture, reweigh frequency channels of a decoded picture, apply frequency jitter to a decoded picture, and the like.

Prior to performing an inverse transform operation 120, or instead of performing an inverse transform operation 120, one or more processors of the computing system can be configured to input a decoded picture 126 into a learning model 128. One or more processors of a computing system can input the decoded picture 126 into any layer of a learning model 128, which further configures the one or more processors to perform training or inference computations based on the decoded picture 126.

A computing system can perform any, some, or all of outputting a reconstructed picture 122; performing an image processing operation 124 upon a decoded picture 126; and inputting a decoded picture 126 into a learning model 128, without limitation.

Given an image compression process 100 in accordance with a variety of image coding techniques as described above, learning-based coding can be incorporated into the image compression process 100. Learned image compression (“LIC”) architectures generally fall into two categories: hybrid coding, and end-to-end learning-based coding.

End-to-end learning-based coding generally refers to modifying one or more of the steps of the overall image compression process 100 such that parameters learned by one or more learning models. Separate from the image compression process 100, on another computing system, datasets can be input into learning models to train the learning models to learn parameters to improve the computation and output of results required for the performance of various computational tasks.

By way of example, LIC is implemented by a Variational Auto-Encoder architecture (“VAE”), which further includes an encoder f_{φ}(x), a decoder g_{θ}(z), and a quantizer q(y). x is an input image, y=f_{φ}(x) is a latent representation, z=q(y) is a quantized and encoded bitstream (e.g., through lossless arithmetic coding) for storage and transmission. Since the deterministic quantization is non-differentiable with regard to network parameters φ and θ, the additive uniform noise is generally used to optimize an approximated differentiable rate distortion (“RD”) loss, as described in Equation 1 below:

$${min}_{φ , θ} {E}_{p ( x ) {p}_{φ} ( Z \vert 𝒳 )} [ λ D ( x , {g}_{θ} ( z ) ) + R ( z ) ]$$

where p(x) is the probability density function of all natural images, D (x, g_{θ}(z)) is a distortion loss (e.g., mean-square error (“MSE”) or mean absolute error (“MAE”)) between the original input and the reconstruction, R(z) is a rate loss estimating the bitrate of the encoded bitstream, and λ is a hyperparameter that controls the optimization of the network parameters to trade off reconstruction quality against compression bitrate. In general, for each target value of λ, a set of model parameters φ and θ needs to be trained for the corresponding optimization of Equation 1.

A learning model can include one or more sets of computer-readable instructions executable by one or more processors of a computing system to perform tasks that include processing input and various parameters of the model, and outputting results. A learning model can be, for example, a layered model such as a deep neural network, which can have a fully-connected structure, can have a feedforward structure such as a convolutional neural network (“CNN”), can have a backpropagation structure such as a recurrent neural network (“RNN”), or can have other architectures suited to the computation of particular tasks. Generally, any layered model having multiple layers between an input layer and output layer is a deep neural network (“DNN”).

Tasks can include, for example, classification, clustering, matching, regression, semantic segmentation, and the like. Tasks can provide output for the performance of functions supporting computer vision or machine vision functions, such as recognizing objects and/or boundaries in images and/or video; tracking movement of objects in video in real-time; matching recognized objects in images and/or video to other images and/or video; providing annotations or transcriptions of images, video, and/or audio in real-time; and the like.

Deep generative models, including VAE and Generative Adversarial Networks (“GAN”), have been applied to improve performance of facial video compression. In 2018, Wiles designed X2Face to control face generation via images, audio, and pose codes. Moreover, Zakharov et al. presented a realistic neural talking head models via few-shot adversarial learning.

For video-to-video synthesis tasks, an NVIDIA research team first proposed Face-vidtovid in 2019. Subsequently, in 2020, they proposed a novel scheme leveraging compact 3D keypoint representation to drive a generative model for rendering the target frame. Moreover, a Facebook research team designed a mobile-compatible video chat system based on a first-order motion model (“FOMM”).

Feng et al. proposed VSBNet, utilizing adversarial learning to reconstruct origin frames from the landmarks. In addition, Chen et al. proposed an end-to-end talking-head video compression framework based upon compact feature learning (“CFTE”), for high efficiency talking facial video compression towards ultra-low bandwidth scenarios. CFTE leverages the compact feature representation to compensate for the temporal evolution and reconstruct the target facial video frame in an end-to-end manner, and can be incorporated into the video coding framework with the supervision of rate-distortion objective. In addition, Chen et al. utilized the facial semantics via the 3D morphable model (“3DMM”) template to characterize facial video and implement face manipulation for facial video coding.

Table 1 below further summarizes facial representations for generative face video compression algorithms. Face images exhibit strong statistical regularities, which can be economically characterized with 2D landmarks, 2D keypoints, region matrix, 3D keypoints, compact feature matrix and facial semantics. Such facial description strategies can lead to reduced coding bit-rate and improve coding efficiency, thus being applicable to video conferencing and live entertainment.

| Facial | |
|---|---|
| representation | Interpretation |
| 2D landmarks | VSBNet is a representative model which can utilize 98 groups of 2D facial landmarks [symbol] ^{2×98} |
| | to depict the key structure information of human face, where the total number of encoding |
| | parameters for each inter frame is 196. |
| 2D keypoints and | FOMM is a representative model which adopts 10 groups of learned 2D keypoints |
| affine transformation | [symbol] ^{2×10} along with their local affine transformations [symbol] ^{2×2×10} to characterize complex |
| matrix | motions. The total number of encoding parameters for each inter frame is 60. |
| Region matrix | MRAA is a representative model which extracts consistent regions of talking face to |
| | describe locations, shape, and pose, mainly represented with shift matrix [symbol] ^{2×10}, covar |
| | matrix [symbol] ^{2×2×10} and affine matrix [symbol] ^{2×2×10}. As such, the total number of encoding |
| | parameters for each inter frame is 100. |
| 3D keypoints | Face_vid2vid is a representative model which can estimate 12-dimension head parameters |
| | (i.e., rotation matrix [symbol] ^{3×3} and translation parameters [symbol] ^{3×1}) and 15 groups of learned 3D |
| | keypoint perturbations [symbol] ^{3×15} due to facial expressions, where the total number of encoding |
| | parameters for each inter frame is 57. |
| Compact feature | CFTE is a representative model which can model the temporal evolution of faces into |
| matrix | learned compact feature representation with the matrix [symbol] ^{4×4}, where the total number of |
| | encoding parameters for each inter frame is 16. |
| Facial semantics | IFVC is a representative model which adopts a collection of transmitted facial semantics to |
| | represent the face frame, including mouth parameters [symbol] ⁶, eye parameter [symbol] ¹, rotation |
| | parameters [symbol] ³, translation parameters [symbol] ³ and location parameter [symbol] ¹. Totally, the number of |
| | encoding parameters for each inter frame is 14. |

FIG. 1B illustrates a flowchart of a deep learning model-based video generative compression FOMM. The FOMM proposed by Siarohin et al. deforms a reference source frame to follow the motion of a driving video, and applies this to face videos in particular. The FOMM of FIG. 1B implements an encoder-decoder architecture with a motion transfer component.

The encoder encodes the source frame by a block-based image or video compression method, such as HEVC/VVC or JPEG/BPG. As illustrated in FIG. 1B, a block-based encoder 152 as described above with reference to FIG. 1A configures one or more processors of a computing system to compress the source frame according to VVC.

One or more processors of a computing system are configured to learn a keypoint extractor using an equivariant loss, without explicit labels. The keypoints (x, y) collectively represent the most important information of a feature map. A source keypoint extractor 154 and a driving keypoint extractor 156 respectively configure one or more processors of a computing system to compute two sets of ten learned keypoints for the source and driving frames. A Gaussian mapping operation 158 configures one or more processors of a computing system to transform the learned keypoints from the feature map with the size of channelX64×64. Thus, every corresponding keypoint can represent feature information of different channels.

A dense motion network 160 configures one or more processors of a computing system to, based on the landmarks and the source frame, output a dense motion field and an occlusion map.

A decoder 162 configures one or more processors of a computing system to generate an image from the warped map.

FIG. 1C illustrates a flowchart of a deep learning model-based video generative compression model based on compact feature representation, namely CFTE proposed by Chen et al. The model of FIG. 1C implements an encoder-decoder architecture which processes a sequence of frames, including a key frame and multiple subsequent inter frames.

The encoder side includes a block-based encoder 172 for compressing the key frame, a feature extractor 174 for extracting the compact human features of the other inter frames, and a feature coding module 176 for compressing the inter-predicted residuals of compact human features.

A feature extractor should be understood as a learning model trained to extract human features from picture data input into the learning model.

The block-based encoder 172 configures one or more processors of a computing system to compress a key frame which represents human textures, herein according to VVC.

The compact feature extractor 174 configures one or more processors of a computing system to represent each of the subsequent inter frames with a compact feature matrix with the size of 1×4×4. The size of compact feature matrix is not fixed and the number of feature parameters can also be increased or decreased according to the specific requirement of bit consumption.

These extracted features are inter-predicted and quantized as described above with reference to FIG. 1A. The feature coding module 176 configures one or more processors of a computing system to entropy-code the residuals and transmit the coded residuals in a bitstream.

The decoder side includes a block-based decoder 178 for reconstructing the key frame, a feature decoding module 180 for reconstructing the compact features by entropy decoding and compensation, and a deep generative model 182 for outputting a video for display based on the reconstructed features and decoded key frame.

The block-based decoder 178 configures one or more processors of a computing system to output a decoded key frame from the transmitted bitstream, herein according to VVC.

The feature decoding module 180 configures one or more processors of a computing system to perform compact feature extraction on the decoded key frame to output features.

Subsequently, given the features from the key and inter frames, a relevant sparse motion field is calculated, facilitating the generation of the pixel-wise dense motion map and occlusion map.

The deep generative model 182 configures one or more processors of a computing system to output a video for display based on the decoded key frame, pixel-wise dense motion map and occlusion map with implicit motion field characterization, generating appearance, pose, and expression.

The 32nd meeting of the Joint Video Experts Team (“JVET”) in October 2023 convened an ad hoc group on Generative Face Video Compression (“GFVC”), including software implementation, test conditions, coordinated experimentation, and interoperability studies thereof. A unified software package, accommodating different GFVC methods through various face video representations and enabling coding with the VVC Main 10 profile, was proposed. The results showed that GFVC could achieve significantly better reconstruction quality than the existing VVC standard at ultra-low bitrate ranges.

This software package only supported entropy coding the first frame and synthesizing, without entropy coding, subsequent frames based on neural networks, e.g., FOMM, Face_vid2vid, and CFTE. However, when the video frames shake violently, it is necessary to code the intermediate frame to ensure the continuity of the video sequence. Wang et al. proposed calculating mean square error (“MSE”) of features generated by the neural network, where, if the MSE is greater than a preset MSE threshold, the current frame is considered to have significantly changed and the current frame needs to be re-coded rather than synthesized by the neural network. However, setting the MSE threshold is a challenging problem due to the different range of features values generated by different neural networks.

Therefore, example embodiments of the present disclosure provide computing a relative difference metric describing differences in features between frames, and determining, based on the relative difference metric, whether a current frame can be synthesized by a generative neural network without entropy coding, or should be re-coded.

The training stage of GFVC utilizes GANs to generate realistic images; however, the training of GANs is very unstable, especially in GFVC, which uses only a few keypoints to generate the entire video frame.

Therefore, example embodiments of the present disclosure provide two-stage training to stabilize GAN training in GFVC.

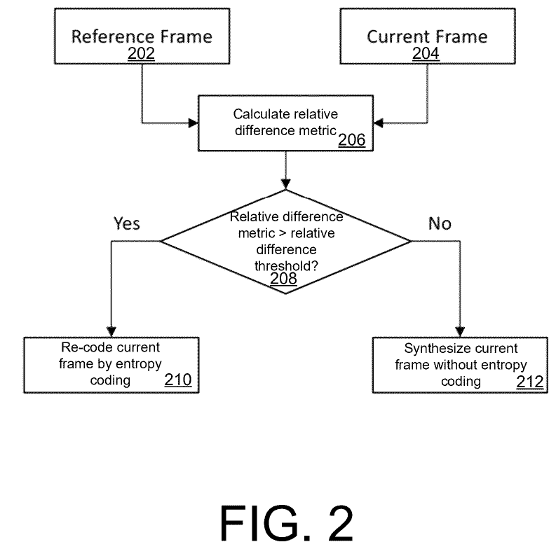

FIG. 2 illustrates a flowchart of calculating a relative difference metric describing differences in features between frames, and determining, based on the relative difference metric, whether to re-code a current frame or synthesize the current frame by a generative neural network.

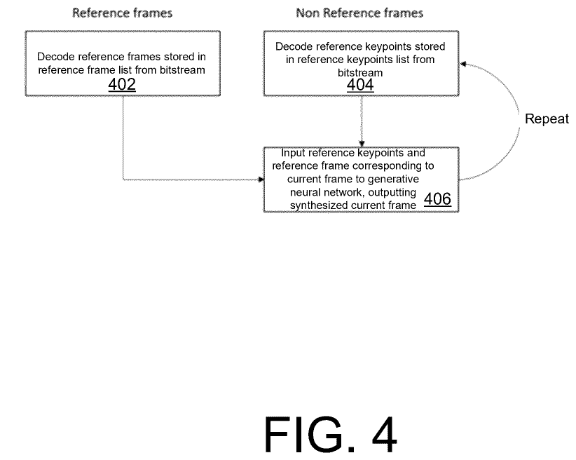

First, one or more processors of a computing system are configured to input a current frame 202 and a reference frame 204 as the forward inputs of a learning model to output respective features thereof, where the learning model can be, without limitation thereto, any learning model as described above. Next, at a step 206, one or more processors of a computing system are configured to calculate a relative difference metric between features of current frame 202 and features of the reference frame 204. Next, at a step 208, magnitude of the relative difference metric is compared against a relative difference threshold; at a step 210, if the relative difference metric exceeds the relative difference threshold, one or more processors of a computing system are configured to re-code the current frame 202 by entropy coding, and, at a step 212, if the relative difference metric is less than the relative difference threshold, one or more processors of a computing system are configured to synthesize the current frame 202 by a generative neural network, without entropy coding, at decoder-side, as described subsequently with reference to FIG. 4.

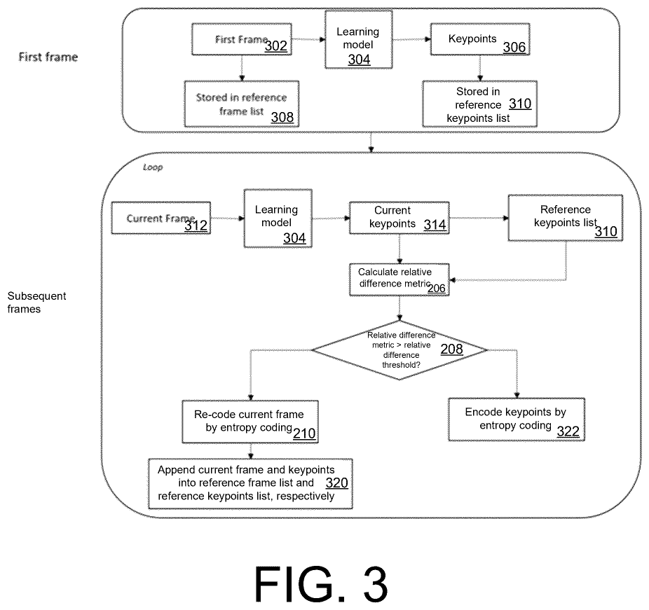

Calculating the relative difference metric according to step 206 is described in further detail subsequently with reference to FIG. 3.

FIG. 3 illustrates a flowchart of an encoder-side sequential frame processing method according to GFVC, and calculation of a relative difference metric based on the frame processing method according to example embodiments of the present disclosure.

An encoder configures one or more processors of a computing system to encode a first frame 302 of a video sequence, and one or more processors of a computing system are configured to input the first frame 302 to a learning model 304 to output keypoints 306 of the first frame 302, where the learning model 304 can be, without limitation thereto, any learning model as described above, and where “keypoints” should be understood as coordinates of a frame which describe objects present in a frame. The first frame is subsequently referred to as a “reference frame,” and the keypoints of the first frame are subsequently referred to as “reference keypoints.” One or more processors of a computing system are configured to generate a reference frame list 308 and a reference keypoints list 310, and store the reference frame and reference keypoints respectively in the reference frame list 308 and the reference keypoints list 310.

One or more processors of a computing system are configured to sequentially input each subsequent current frame 312 to the learning model 304 to output current keypoints 314 of the current frame 312. For each current frame 312, one or more processors of a computing system are configured to calculate an absolute difference of current keypoints 314 and reference keypoints (as stored in the reference keypoints list 310) by a distance function. A distance function, such as MAE, MSE, Kullback-Leibler divergence (“KL-divergence”) or cross-entropy, measures the distance between two data points. Absolute difference of current keypoints and reference keypoints can be described by the following Equation 2:

$$Absolute difference = f ( current keypoints , reference keypoints )$$

Herein, f(·) is any abovementioned distance function. A previous absolute difference of current keypoints and reference keypoints is stored in a moving window of any length, or of a fixed size, by an append function. For the current frame 312, a mean of the moving window is calculated by one or more processors of a computing system according to Equation 3 below. The absolute difference of current keypoints and reference keypoints is divided by the mean of the moving window by one or more processors of a computing system, as shown in Equation 4 below, to yield a relative difference of current keypoints and reference keypoints, the relative difference of current keypoints and reference keypoints being the relative difference metric.

$$\begin{matrix}mean = \frac{sum ( moving window )}{l e ngth ( moving window )} \\ relative difference metric = \frac{A b s olute difference}{m e a n}\end{matrix}$$

This calculation of a relative difference metric should be understood as an example of step 206 of FIG. 2 above.

For each current frame 312, a relative difference metric measures the relative difference between the current frame and a reference frame in a global scope. One or more processors of a computing system are configured to compare the relative difference metric to a relative difference threshold at a step 208: if the relative difference metric exceeds the relative difference threshold, the current frame 312 is labeled as another reference frame, and the current keypoints 314 are labeled as further reference keypoints; after the encoder configures one or more processors of a computing system to re-code the current frame at a step 210, one or more processors of a computing system are configured to append the newly labeled reference frame and the newly labeled reference keypoints to a reference frame list 308 and a reference keypoints list 310, respectively, at a step 320.

If the relative difference metric is less than the relative difference threshold, one or more processors of a computing system are configured to encode the current keypoint by entropy coding at a step 322, such as arithmetic coding and Context-based Adaptive Binary Arithmetic Coding (“CABAC”).

Each subsequent current frame 312 remaining in a video sequence is processed as above.

FIG. 4 illustrates a flowchart of a decoder-side sequential frame processing method according to GFVC, based on a relative difference metric according to example embodiments of the present disclosure.

At a step 402, a decoder configures one or more processors of a computing system to decode reference frames stored in a reference frame list 308 from a bitstream.

At a step 404, for each non-reference frame, a decoder configures one or more processors of a computing system to decode reference keypoints stored in a reference keypoints list 310 from the bitstream.

At a step 406, a generative neural network configures one or more processors of a computing system to input the reference keypoints and a reference frame corresponding to the current frame to the generative neural network, outputting a current frame synthesized by the generative neural network, without entropy coding.

Steps 404 and 406 are repeated for each subsequent frame remaining in a video sequence.

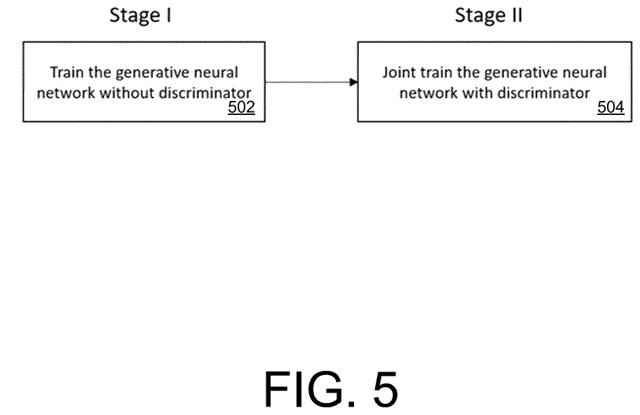

Furthermore, example embodiments of the present disclosure provide two-stage training to stabilize GAN training in GFVC. FIG. 5 illustrates two-stage training according to example embodiments of the present disclosure.

At a step 502, one or more processors of a computing system train a generative neural network without a discriminator, such that a gradient of the generative neural network in the training stage is not disturbed by the discriminator.

At a step 504, one or more processors of a computing system joint train the generative neural network with a discriminator, such that the generative neural network has the ability to synthesize high-quality images.

Persons skilled in the art will appreciate that all of the above aspects of the present disclosure may be implemented concurrently in any combination thereof, and all aspects of the present disclosure may be implemented in combination as yet another embodiment of the present disclosure.

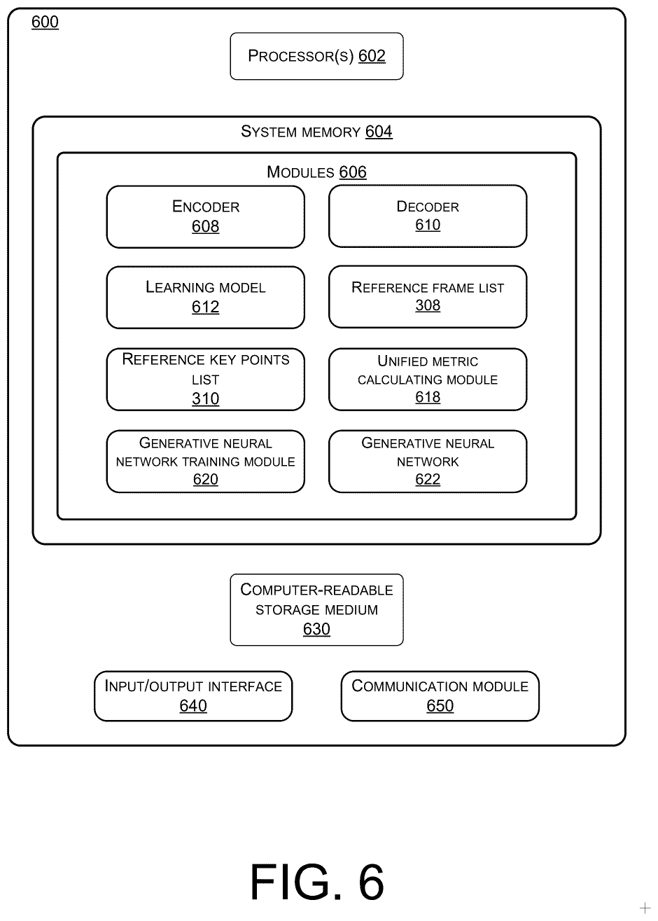

FIG. 6 illustrates an example system 600 for implementing the processes and methods described above for computing a relative difference metric describing differences in features between frames, and determining, based on the relative difference metric, whether a current frame can be synthesized by a generative neural network without entropy coding, or should be re-coded.

The techniques and mechanisms described herein may be implemented by multiple instances of the system 600 as well as by any other computing device, system, and/or environment. The system 600 shown in FIG. 6 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 600 may include one or more processors 602 and system memory 604 communicatively coupled to the processor(s) 602. The processor(s) 602 may execute one or more modules and/or processes to cause the processor(s) 602 to perform a variety of functions. In some embodiments, the processor(s) 602 may include a central processing unit (“CPU”), a graphics processing unit (“GPU”), both CPU and GPU, or other processing units or components known in the art. Additionally, each of the processor(s) 602 may possess its own local memory, which also may store program modules, program data, and/or one or more operating systems.

Depending on the exact configuration and type of the system 600, the system memory 604 may be volatile, such as RAM, non-volatile, such as ROM, flash memory, miniature hard drive, memory card, and the like, or some combination thereof. The system memory 604 may include one or more computer-executable modules 606 that are executable by the processor(s) 602.

The modules 606 may include, but are not limited to, an encoder 608, a decoder 610, a learning model 612, a reference frame list 308, a reference keypoints list 310, a relative difference metric calculating module 618, a generative neural network training module 620, and a generative neural network 622 as described above with reference to FIGS. 3, 4, and 5, and Table 1.

The encoder 608 configures the one or more processor(s) 602 to perform picture coding by any of the techniques and processes described above, such as an image compression process 100 of FIG. 1.

The decoder 610 configures the one or more processor(s) 602 to perform picture coding by any of the techniques and processes described above, such as an image compression process 100 of FIG. 1.

The learning model 612 configures the one or more processors(s) 602 to output keypoints of a frame as described above with reference to FIG. 3.

The reference frame list 308 and reference keypoints list 310 are as described above with reference to FIG. 3.

The relative difference metric calculating module 618 configures the one or more processor(s) to calculate a relative difference metric as described above with reference to FIG. 3.

The generative neural network training module 620 configures the one or more processor(s) to perform two-stage training as described above with reference to FIG. 5.

The system 600 may additionally include an input/output (I/O) interface 640 for receiving input picture data and bitstream data, and for outputting decoded pictures to a display, an image processor, a learning model, and the like. The system 600 may also include a communication module 650 allowing the system 600 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium 630, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transitory computer-readable storage media that, when executed by one or more processors, may perform operations described above with reference to FIGS. 1-5. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
computing, by one or more processors of a computing system, a relative difference metric describing differences in features between a current frame and a reference frame; and
determining, by the one or more processors, based on the relative difference metric, whether to synthesize the current frame by a generative neural network without entropy coding.

2. The method of claim 1, wherein computing the relative difference metric further comprises:
inputting, by the one or more processors, the current frame and the reference frame into a learning model; and
outputting, by the one or more processors, current keypoints of the current frame and reference keypoints of the reference frame.

3. The method of claim 2, wherein computing the relative difference metric further comprises:
calculating, by the one or more processors, an absolute difference of the current keypoints and the reference keypoints.

4. The method of claim 3, wherein computing the relative difference metric further comprises:
dividing, by the one or more processors, the absolute difference by a mean of a moving window, wherein the moving window comprises a previous absolute difference.

5. The method of claim 3, wherein calculating the absolute difference further comprises applying, by the one or more processors, a distance function to the current keypoints and the reference keypoints.

6. The method of claim 4, wherein the distance function does not comprise mean square error.

7. The method of claim 1, wherein determining, based on the relative difference metric, whether to synthesize the current frame further comprises:
comparing, by the one or more processors, the relative difference metric to a relative difference threshold.

8. The method of claim 1, further comprising:
decoding, by the one or more processors, reference frames stored in a reference frame list from a bitstream;
decoding, by the one or more processors, a reference keypoint stored in a reference keypoints list from a bitstream;
inputting, by the one or more processors, the reference keypoints and a reference frame corresponding to the current frame to a generative neural network; and
outputting, by the one or more processors, a current frame synthesized by the generative neural network without entropy coding.

9. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
computing a relative difference metric describing differences in features between a current frame and a reference frame; and

10. The computing system of claim 9, wherein computing the relative difference metric further comprises:
inputting the current frame and the reference frame into a learning model; and
outputting current keypoints of the current frame and reference keypoints of the reference frame.

11. The computing system of claim 10, wherein computing the relative difference metric further comprises:
calculating an absolute difference of the current keypoints and the reference keypoints.

12. The computing system of claim 11, wherein computing the relative difference metric further comprises:
dividing the absolute difference by a mean of a moving window, wherein the moving window comprises a previous absolute difference.

13. The computing system of claim 11, wherein calculating the absolute difference further comprises applying a distance function to the current keypoints and the reference keypoints.

14. The computing system of claim 13, wherein the distance function does not comprise mean square error.

15. The computing system of claim 9, wherein determining, based on the relative difference metric, whether to synthesize the current frame further comprises:
comparing the relative difference metric to a relative difference threshold.

16. The computing system of claim 9, wherein the operations further comprise:
decoding reference frames stored in a reference frame list from a bitstream;
decoding a reference keypoint stored in a reference keypoints list from a bitstream;
inputting the reference keypoints and a reference frame corresponding to the current frame to a generative neural network; and
outputting a current frame synthesized by the generative neural network without entropy coding.

17. A method comprising:
training, by one or more processors of a computing system, a generative neural network without a discriminator; and
training, by the one or more processors of a computing system, the generative neural network with a discriminator.
